(19) United States
(12) Patent Application Publication
(10) Pub. No.: US 2012/0116624 A1
(43) Pub. Date: May 10, 2012

(54) METHOD FOR CONTROLLING A HYBRID DRIVE TRAIN OF A MOTOR VEHICLE

(75) Inventor: Ulrich Reith, Schlier (DE)

(73) Assignee: ZF FRIEDRICHSHAFEN AG, Friedrichshafen (DE)

(21) Appl. No.: 13/274,568

(22) Filed: Oct. 17, 2011

(30) Foreign Application Priority Data
Nov. 9, 2010 (DE) 10 2010 043 591.0

(51) Int. Cl. B60W 10/30; B60W 20/00

(52) U.S. Cl. 701/22

(57) ABSTRACT

A method of controlling a hybrid drive train of a vehicle that comprises an internal combustion engine with a drive shaft, an automatic stepped transmission with an input shaft that can be connected, via a clutch, to the engine drive shaft, an electric machine, which can be operated as a motor and a generator, a rotor connected with the engine drive shaft, and a power take-off connected with the engine drive shaft, the power-take-off drives an attached assembly. In order to compensate or at least diminish the inertia-dependent effects of the assembly permanently driven by the power take-off, during a controlled change of the rotational speed of the combustion engine, the inertia-dependent torque of the power take-off and the attached assembly, that is counteracting the rotational speed change, is largely compensated by the torque, counter to this, that is output or absorbed by the electric machine.

This application claims priority from German patent application serial no. 10 2010 043 591.0 filed Nov. 9, 2010.

### FIELD OF THE INVENTION

The invention relates to a method for controlling a hybrid drive train of a motor vehicle, for example a commercial vehicle, that comprises an internal combustion engine with a drive shaft, an automatic stepped transmission with an input shaft that can be connected by means of a controllable separating clutch to the drive shaft of the internal combustion engine, an electric machine, which can be operated as a motor and as a generator, with a rotor in driving connection with the drive shaft of the internal combustion engine, and a power take-off drive in driving connection with the drive shaft of the internal combustion engine, where the power take-off drive drives an attached assembly.

### BACKGROUND OF THE INVENTION

The invention further relates to a method for controlling a hybrid drive train of a motor vehicle, for example a commercial vehicle, that comprises an internal combustion engine with a drive shaft, an automatic stepped transmission with an input shaft that can be connected by means of a controllable separating clutch to the drive shaft of the internal combustion engine, an electric machine, which can be operated as a motor and as a generator, with a rotor in driving connection with the input shaft of the stepped transmission, and a power take-off drive in driving connection with the input shaft of the stepped transmission, wherein the power take-off drive drives an attached assembly.

Commercial vehicles in particular, are frequently equipped with at least one power take-off drive in the drive train that can temporarily or permanently drive a connected assembly with torque available from the drive train. A so-called motor dependent power take-off drive can be used for a permanent drive, i.e. active power take-off drive both during vehicle standstill as well as while driving, in which the relevant output flange is in driving connection, via a gear train, with the drive shaft of the internal combustion engine. Alternatively, a so-called clutch dependent power take-off can be used, in which the relevant output flange is in driving connection, via a gear train, with the input shaft of the stepped transmission. Typical motor vehicles with permanent power take-off drive are cement mixers, refrigerated trucks and airfield firefighting vehicles, in which the relevant assembly, for instance the mixing drum, the refrigerating compressor or the extinguisher pump, must be permanently driven in the loaded state and during extinguishing.

A disadvantage of an assembly permanently driven by a power take-off drive is, however, that the rotating parts of the power take-off drive and the assembly attached thereto, must also be accelerated or decelerated during acceleration or deceleration of the motor vehicle, as well as with shift-dependent adjustments of the rotational speed of the internal combustion engine, or the synchronization of the target gear with a gear change within the stepped transmission. Compared to a driving mode with a switched off power take-off drive, this results in significantly changed operating behavior in the form of a longer start-up with a longer slip phase of the separating clutch, and in the form of lower acceleration or deceleration during travel. This also results in a changed shifting procedure in the form of a changed duration of the shift with a longer interruption of the tractive force, which can lead to an undesired deceleration in an incline section and an undesired acceleration in a downhill section.

On the other hand, there is a continued trend to introduce hybrid drives with at least one electric machine, which can be operated as a motor and as a generator, integrated in a conventional drive train. Thus, the arrangement of an electric machine identified as a crankshaft starter generator at a disk flywheel fastened to a crankshaft of an internal combustion engine is known. It is also known to arrange an electric machine at the input shaft of a stepped transmission, where the rotor of the electric machine can be connected directly to the input shaft, or can be in driving connection with the input shaft via a reduction gear.

The document, DE 10 2007 055 830 A1, describes a method that relates to a hybrid drive train with an electric machine arranged at the input shaft of a stepped transmission, and with which the internal combustion engine is started from electric driving operation by engaging the separating clutch during a shifting procedure within the stepped transmission. In a further possible arrangement according to the patent application US 2009/0018716 A1, the electric machine is disposed directly at a transmission-side power take-off drive of a stepped transmission.

### SUMMARY OF THE INVENTION

The objective of the invention is based on the insight that the previously named disadvantages of an assembly permanently driven by a power take-off drive can largely be avoided when the electric machine is favorably connected with respect to drive technology and is controlled in a suitable manner. The invention is based on the problem to specify a control method for the two hybrid drive trains of the initially named type that are suitable for this purpose, with which the respective inertia-dependent effects of an assembly permanently driven by the respective power take-off drive can be compensated or at least reduced.

Regarding the first variant embodiment of a hybrid drive train suitable for this purpose, this problem is solved according to the invention with a controlled rotational speed change, i.e. by a targeted rotational speed change dn_{VM}/dt of the internal combustion engine, brought about by control measures, the inertia-dependent torque of the power take-off drive and of the assembly connected thereto, that is counteracting the rotational speed change, is largely compensated by the counteracting torque M_{EM} that is output or absorbed by the electric machine EM.

Accordingly, the invention proceeds from a known hybrid drive of a motor vehicle, of a commercial vehicle for example, that comprises an internal combustion engine with a drive shaft, an automatic stepped transmission with an input shaft that can be connected to the drive shaft of the internal combustion engine via a controllably engaging and disengaging separating clutch, i.e. by means of a controllable clutch actuator, an electric machine that can be operated as a motor and as a generator having a rotor in driving connection with the drive shaft of the internal combustion engine, and a so-called motor-dependent power take-off drive in driving connection with the drive shaft of the internal combustion engine to which an assembly is attached, such as the drive of a cement mixing drum, the compressor of a cooling system or the extinguishing pump of a fire extinguishing system.

With permanent drive of the assembly attached to the power take-off drive PTO, the method according to the invention generally provides that with a controlled change of rotational speed dn_{VM}/dt of the internal combustion engine, the inertia-dependent torque of the power take-off drive PTO and of an assembly permanently driven by it that opposes the rotational speed change is largely compensated by the counteracting torque M_{EM} that is output or absorbed by the electric machine EM.

If the maximum torque (driving torque, M_{EM}>0) that can be delivered by the electric machine EM in motor mode in the case of acceleration of the internal combustion engine and the maximum torque (braking toque, M_{EM}<0) that can be absorbed by the electric machine EM in generator mode in the case of decelerating the internal combustion engine are sufficient, the inertia-dependent effect of the power take-off drive PTO and of the assembly connected to it can be completely compensated. The acceleration and deceleration behavior of the internal combustion engine then corresponds exactly to the behavior without the connected assembly, or with the power take-off drive PTO switched off. As a result, the driver cannot detect any difference in the drive behavior with or without the active power take-off drive PTO.

If, however, the maximum torque (driving torque, M_{EM}>0) that can be delivered by the electric machine EM in motor mode in the case of acceleration of the internal combustion engine, and the maximum torque (braking toque, M_{EM}<0) that can be absorbed by the electric machine EM in generator mode in the case of decelerating the internal combustion engine are not sufficient, the inertia-dependent effect of the power take-off drive PTO and of the assembly connected to it can be detected by the driver, however, the effect is weakened, and therefore, less relevant.

During an upshift, in particular a tractive upshift within the stepped transmission, according to the invention during the upshift, adapting the rotational speed of the internal combustion engine is supported in that the electric machine EM in generator mode absorbs a corresponding braking torque (M_{EM}<0). This results in decelerating the drive shaft of the internal combustion engine within the scope of adapting the rotational speed without engaging the engine control, in roughly the same time span as without the connected assembly or with the power take-off drive PTO switched off, so that no deceleration occurs in the shifting procedure of the upshift.

Analogous to this, during downshifts, in particular a coasting downshift within the stepped transmission, according to the invention during the downshift, adapting of the rotational speed of the internal combustion engine is supported in that the electric machine EM in motor mode delivers a corresponding driving torque (M_{EM}>0). This results in accelerating the drive shaft of the internal combustion engine within the scope of adapting the rotational speed without engaging the engine control, in roughly the same time span as without the connected assembly or with the power take-off drive PTO switched off, so that no deceleration occurs in the shifting procedure of the downshift.

If the moment of inertia J_{PTO} of the power take-off drive PTO and the assembly connected thereto is known, e.g. from relevant manufacturer's data or from comparisons of acceleration with and without the power take-off drive PTO switched on, the amount of the torque M_{EM} to be absorbed or delivered by the electric machine EM for its compensation can be determined according to the equation

M_{EM}=J_{PTO}*π/(30*i_{EM}*i_{PTO}²)*dn_{VM}/dt

where i_{EM} is the transmission ratio between the rotor of the electric machine EM and the drive shaft of the internal combustion engine, i_{PTO} is the transmission ratio between the drive shaft of the internal combustion engine and the output flange of the power take-off drive PTO, and dn_{VM}/dt is the intended rotational speed gradient at the drive shaft of the internal combustion engine.

Regarding the second variant embodiment of a hybrid drive train suitable for this purpose, this problem addressed by the invention is solved with a controlled rotational speed change, i.e. by a targeted rotational speed change dn_{GE}/dt of the input shaft GE of the stepped transmission, brought about by control measures, the inertia-dependent torque of the power take-off drive PTO′ and of the assembly connected thereto, that is counteracting the rotational speed change, is largely compensated by the counteracting torque M_{EM}′ that is output or absorbed by the electric machine EM′.

In this case, the invention proceeds from a known hybrid drive of a motor vehicle, of a commercial vehicle for example, that comprises an internal combustion engine with a drive shaft, an automatic stepped transmission with an input shaft that can be connected to the drive shaft of the internal combustion engine via a controllably engaging and disengaging separating clutch, i.e. by means of a controllable clutch actuator, an electric machine EM′ that can be operated as a motor and as a generator having a rotor in driving connection with the input shaft of the stepped transmission, and a so-called clutch-dependent power take-off drive PTO′ in driving connection with the input shaft of the stepped transmission, to which an assembly is attached, such as the drive of a cement mixing drum, the compressor of a cooling system or the extinguishing pump of a fire extinguishing system.

With a permanent drive of the assembly attached to the power take-off drive PTO′, the method according to the invention generally provides that with a controlled change of rotational speed dn_{GE}/dt of the input shaft GE of the stepped transmission, the inertia-dependent torque of the power take-off drive PTO′ and an assembly permanently driven by it that is opposing the rotational speed change is largely compensated by the counteracting torque M_{EM}′, that is output or absorbed by the electric machine EM′.

If the maximum torque (driving torque, M_{EM}>0) that can be delivered by the electric machine EM′ in motor mode in the case of acceleration of transmission input shaft, and the maximum torque (braking toque, M_{EM}<0) that can be absorbed by the electric machine EM′ in generator mode in the case of decelerating the transmission input shaft are sufficient, then the inertia-dependent effect of the power take-off drive PTO′ and of the assembly connected to it can be completely compensated. The acceleration and deceleration properties of the transmission input shaft then correspond exactly to the properties without the connected assembly, or with the power take-off drive PTO′ switched off. As a result, the driver cannot detect any difference in the drive behavior with or without the active power take-off drive PTO′.

If, however, the maximum torque (driving torque, M_{EM}′>0) that can be delivered by the electric machine EM′ and the maximum torque (braking toque, M_{EM}′<0) that can be absorbed by the electric machine EM′ are not sufficient, the inertia-dependent effect of the power take-off drive PTO′ and of the assembly connected to it is at least greatly reduced by appropriately controlling the electric machine EM′, and therefore, its effect is weakened.

During upshifts, in particular a tractive upshift within the stepped transmission, according to the invention the synchronization of the target gear that occurs by decelerating the input shaft of the stepped transmission, is supported in that the electric machine EM′ in generator mode absorbs a corresponding braking torque (M_{EM}′<0). This results in decelerating the transmission input shaft within the scope of synchronizing the target gear without engaging the transmission control, in roughly the same time span as without the connected assembly or with the power take-off drive PTO′ switched off, so that no deceleration occurs in the shifting procedure of the upshift.

Analogous to this, during downshifts, in particular a coasting downshift within the stepped transmission, according to the invention during the downshift the synchronization of the target gear that occurs by accelerating the input shaft of the stepped transmission is supported in that the electric machine EM′ in motor mode delivers a corresponding driving torque (M_{EM}′>0). This results in accelerating the transmission input shaft within the scope of synchronizing the target gear without engaging the transmission control, in roughly the same time span as without the connected assembly or with the power take-off drive PTO′ switched off, so that no deceleration occurs in the shifting procedure of the downshift.

If the moment of inertia J_{PTO}′ of the power take-off drive PTO′ and of the assembly connected thereto is known, e.g. from relevant manufacturer's data or from comparisons of acceleration with and without the power take-off drive PTO′ switched on, the amount of the torque M_{EM}′ to be absorbed or delivered by the electric machine EM for compensation can be determined according to the equation

M_{EM}′=J_{PTO}′*π/(30*i_{EM}′*i_{PTO}′²)*dn_{GE}/dt

where J_{PTO}′ is the moment of inertia of the power take-off drive PTO′ and of the assembly attached to it, i_{EM}′ is the transmission ratio between the rotor of the electric machine EM′ and the input shaft of the stepped transmission, i_{PTO}′ is the transmission ratio between the input shaft of the stepped transmission and the output flange of the power take-off drive PTO′, and dn_{GE}/dt is the intended rotational speed gradient at the input shaft of the stepped transmission.

For both embodiments of the hybrid drive train, in the case of a start-up with an initially slipping separating clutch the electric machine EM, EM′ in motor mode outputs at least an appropriate driving torque (M_{EM}>0, M_{EM}′>0) for compensating the inertia-dependent torque of the power take-off drive PTO, PTO′ and of the assembly attached to it. Through this, it is guaranteed that the start-up acceleration with the assembly driven by the power take-off drive is not less than during start-up without the power take-off drive and the assembly attached thereto. Also as a result of this, the wear-intensive slip phase of the separating clutch does not last any longer than during start-up without the power take-off drive and the assembly attached thereto.

Likewise, for both variant embodiments of the hybrid drive during acceleration of the motor vehicle during travel with an engaged separating clutch, in particular also during a change from coasting mode to tractive mode, the electric machine EM, EM′ is switched on in the powerless idle state (M_{EM}=0, M_{EM}′=0) for compensating the inertia-dependent torque of the power take-off drive PTO, PTO′ and the assembly connected to this, and then in motor mode provides an appropriate drive toque (M_{EM}>0, M_{EM}′>0), providing an increased driving torque if it is already in motor mode, and absorbing a correspondingly reduced braking torque if it is in the generator mode. As a result of this, the acceleration behavior of the motor vehicle with a driven assembly corresponds largely to the behavior with the assembly switched off.

Analogous to this, for both variant embodiments of the hybrid drive in the case of a deceleration of the motor vehicle during travel with an engaged separating clutch, in particular also during a change from tractive mode to coasting mode, the electric machine EM, EM′ is switched on in the powerless idle state (M_{EM}=0, M_{EM}40 =0) for compensating the inertia-dependent torque of the power take-off drive PTO, PTO′ and the assembly connected to this, and then in generator mode absorbs an appropriate braking toque (M_{EM}<0, M_{EM}′<0), absorbing an increased braking torque in the case it is already in generator mode, and providing a correspondingly reduced driving torque in the case of drive mode. As a result of this, the deceleration behavior of the motor vehicle with a driven assembly corresponds largely to the behavior with the assembly switched off.

### BRIEF DESCRIPTION OF THE DRAWINGS

For illustrating the invention, the description is accompanied by a drawing with exemplary embodiments. They show:

FIG. 1 a schematic diagram of rotational speed curves of the drive shaft of the internal combustion engine or the input shaft of the stepped transmission during a tractive upshift,

FIG. 2 a schematic view of a first variant embodiment of a hybrid drive train with a motor-dependent power take-off drive, and

FIG. 3 a schematic view of a second variant embodiment of a hybrid drive train with a motor-dependent power take-off drive.

### DETAILED DESCRIPTION OF THE PREFERRED EMBODIMENTS

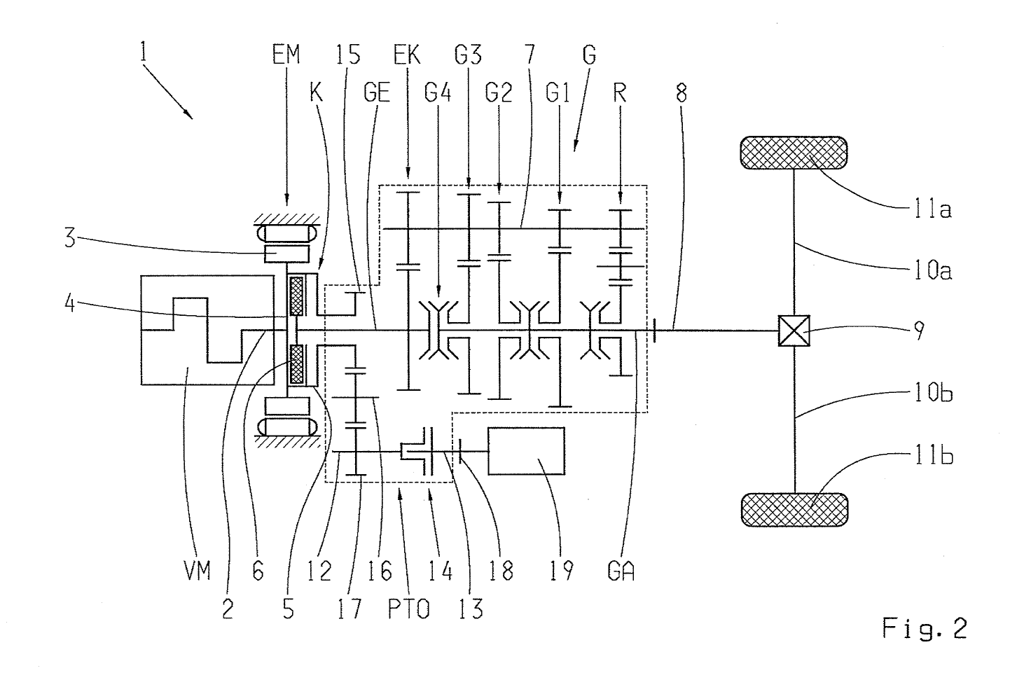

FIG. 2 schematically represents a known first embodiment variant of a hybrid drive train 1 in which the method according to the invention can be applied. The hybrid drive train 1 comprises an internal combustion engine VM with a drive shaft 2, an automatic stepped transmission G with an input shaft GE that can be connected to the drive shaft 2 of the internal combustion engine VM by means of a controllable separating clutch K, an electric machine EM, which can be operated as a motor and as a generator, with a rotor 3 in driving connection with the drive shaft 2 of the internal combustion engine VM, and a so-called motor-dependent power take-off drive PTO in driving connection with the drive shaft 2 of the internal combustion engine VM.

The electric machine EM is designed, for example, as a crankshaft starter generator whose rotor 3 is rigidly fastened to the outer periphery of a flywheel 4 that is mounted to the drive shaft 2 (crankshaft) of the internal combustion engine VM. The separating clutch K is designed as a friction clutch and has a clutch basket 5 fastened to the flywheel 4 and a driving plate 6 disposed in a rotationally fixed manner on the input shaft GE.

The stepped transmission G is designed, for example, as a synchronized countershaft stepped transmission with four forward gears G1, G2, G3, G4 and one reverse gear R. The crankshaft 7 is disposed axis parallel to the input shaft GE and is in driving connection with it via an input constant EK designed as a gear pair. The output shaft GA is disposed coaxially adjacent to the input shaft GE, and for shifting a direct gear G4 can be coupled via a gear coupling to the input shaft GE. The power flow of the other gears G1, G2, G3, R occurs via a respectively assigned gear wheel set, which each comprise a fixed gear disposed in a rotationally fixed manner on the countershaft 7, and an idler that can be rotationally coupled to it on the output shaft GA as well as via an assigned gear coupling. The gear wheel set of the reverse gear R has an additional intermediate gear for reversing the direction of rotation. The output shaft GA is in driving connection via a cardan shaft 8 to an axis differential 9 of a drive shaft, from which, on both sides, an axle shaft 10a, 10b runs to a drive wheel 11a, 11b of the drive axle.

The power take-off drive PTO comprises an input side drive shaft 12 and an output side drive shaft 13, disposed coaxially adjacent to this, that can be connected together and separated from each other via a shifting clutch 14 for engaging and disengaging the power take-off drive PTO. The driving connection between the drive shaft 2 of the internal combustion engine VM and the power take-off drive PTO is designed as a spur wheel gear train, which comprises an output wheel 15 disposed at the clutch basket 5 of the separating clutch K, an intermediate gear 16, and in input gear 17 fastened at the input side drive shaft 12 of the power take-off drive PTO. A drivable assembly 19, for instance the drive of a cement mixer drum, the compressor of a cooling system or the extinguishing pump of a fire extinguishing system, is connected, as needed, at an end side output flange 18 disposed at the output side drive shaft 13 of the power take-off drive PTO.

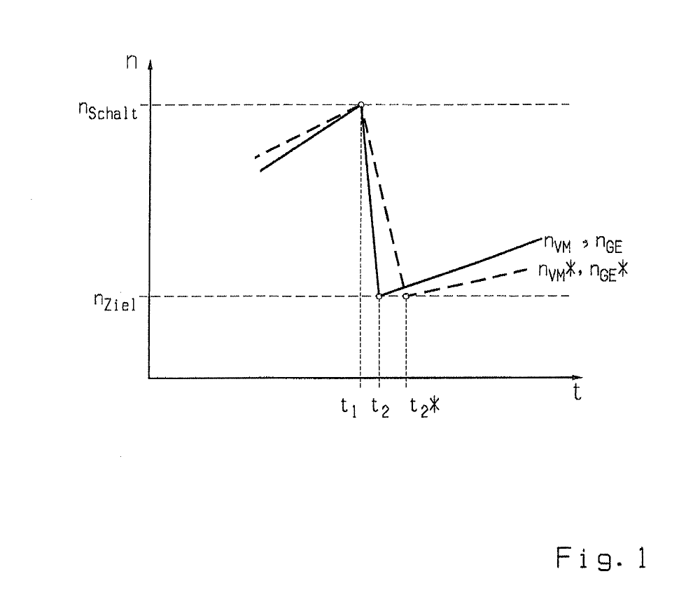

FIG. 1 shows, in simplified form, the possible rotational speed progressions of the drive shaft 2 of the internal combustion engine VM, i.e. the engine rotational speed n_{VM}, n_{VM}*, which can occur during a tractive upshift in the scope of adapting the rotational speed of the internal combustion engine VM and the subsequent further acceleration of the motor vehicle. In drive mode with internal combustion engine with a switched off power take-off drive PTO, i.e. disengaged switching clutch 14, adapting the rotational speed of the internal combustion engine VM occurs corresponding to the solid curve progression for n_{VM} after disengaging the separating clutch K between the shifting rotational speed n_{Schalt} and the target rotational speed n_{Zeil} in the time period between t1 and t2, and largely simultaneously with the synchronization and engagement of the target gear as well as the engagement of the separating clutch K within the stepped transmission G. Afterwards, the motor vehicle is accelerated further by the internal combustion engine VM.

If the power take-off drive PTO is, on the other hand, switched on, i.e. the shifting clutch 14 is engaged, the assembly 19 is in permanent drive connection with the drive shaft 2 of the internal combustion engine VM. Due to the inertia-dependent torque of the power take-off drive PTO and the assembly 19 connected thereto, counteracting a deceleration and acceleration of the internal combustion engine VM, the shift-dependent rotational speed adaptation of the internal combustion engine VM would without further measures occur more slowly (from time t1 to t2*) according to the dashed curve progression for n_{VM}*, so that the shifting procedure would be correspondingly delayed. Likewise, the subsequent further acceleration of the motor vehicle by the internal combustion engine VM would occur more slowly because the assembly 19 attached at the power take-off drive PTO must also be accelerated.

In contrast, according to the invention with a switched on power take-off drive PTO, the electric machine EM is controlled during and after the tractive upshift so that, in generator mode, it absorbs a braking torque (M_{EM}<0) while adapting the rotational speed of the internal combustion engine VM, and during the subsequent acceleration of the motor vehicle, in motor mode, produces a driving torque (M_{EM}>0), that in each case corresponds as closely as possible to the inertia-dependent torque of the power take-off drive PTO and the assembly 19 attached thereto, counteracting the deceleration or acceleration of the drive shaft 2 of the internal combustion engine VM, and compensating this torque. In the case of the tractive upshift considered here, an appropriate control of the electric machine EM results therefore ideally in the rotational speed progression n_{VM} corresponding to the solid line curve progression, so that the shift progression and the subsequent drive acceleration largely correspond to the progressions with the switched off power take-off drive PTO.

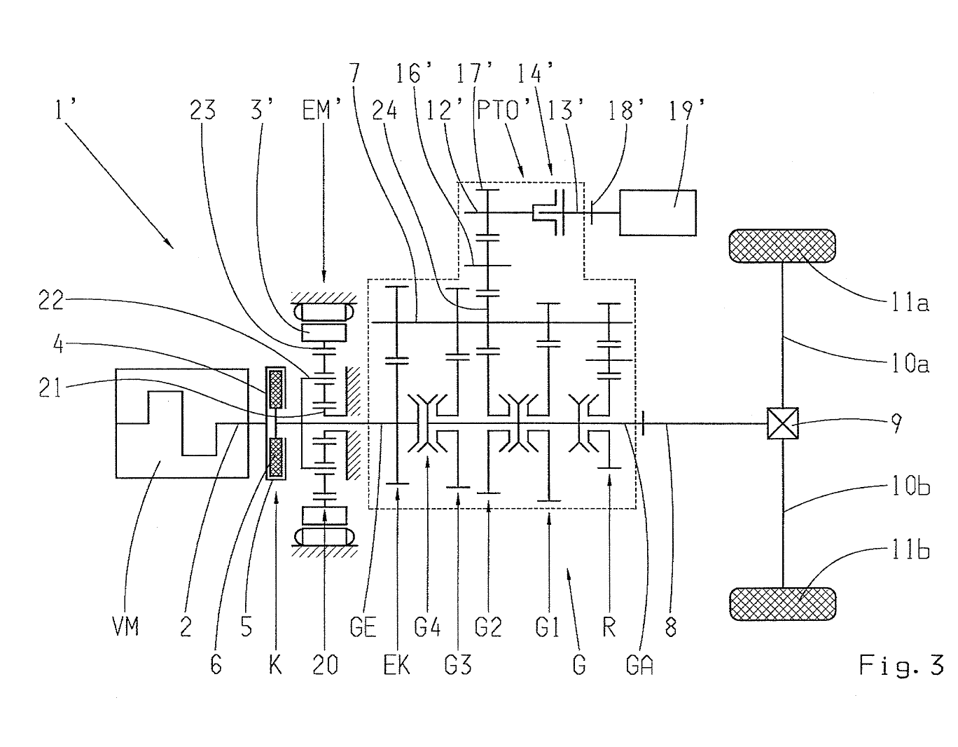

A generally known second embodiment variant of a hybrid drive train 1′, represented schematically in FIG. 3, differs from the first embodiment variant according to FIG. 2 only by a different drive connection of the electric machine EM′ and the power take-off drive PTO′.

The electric machine EM′ is disposed at the input shaft GE of the stepped transmission G, where the rotor 3′ is in driving connection with this input shaft GE via a reduction transmission 20. The reduction transmission 20 is designed for example as a simple planetary transmission, whose sun gear 21 is fixed to the housing, whose planetary carrier 22 is connected in a rotationally fixed manner to the input shaft GE, and whose ring gear 23 is connected in a rotationaly fixed manner to the rotor 3′ of the electric machine EM′. Thus, a transmission ratio in the range of i_{EM}′=1.25 to 1.67 results between the rotor 3′ of the electric machine EM′ and the input shaft GE of the stepped transmission G.

The power take-off drive PTO′, with an otherwise equivalent design, is now designed as a so-called clutch-dependent power take-off drive, and thus, is in driving connection with the input shaft GE of the stepped transmission G. The input shaft GE and the power take-off shaft PTO′ are in driving connection by means of the input constant EK, the countershaft 7 and a spur wheel gear train, which comprises the fixed gear 24 of the gear wheel set of the second gear G2, an intermediate gear 16′ and a drive wheel 17′ fastened at the input shaft side drive shaft 12′ of the power take-off drive PTO′.

For explaining the method according to the invention, the curve progressions represented in FIG. 1 are now considered as rotational speed progressions n_{GE}, n_{GE}* of the input shaft GE of the stepped transmission G, which can occur during a tractive upshift in the context of synchronizing the target gear and the subsequent further acceleration of the motor vehicle. In internal combustion engine travel operation with the power take-off drive PTO′ switched off, i.e. the shifting clutch 14′ is disengaged, the synchronization of the target gear occurs corresponding to curve progression n_{GE}, represented with a solid line, after disengaging the separating clutch K between the shifting rotational speed n_{Schalt} and the target rotational speed n_{Ziel} in the time period between the times t1 and t2, and largely simultaneously with adapting the rotational speed of the internal combustion engine VM. After engaging the target gear and engaging the separating clutch, the motor vehicle is further accelerated by the internal combustion engine VM.

However, if the power take-off drive PTO′ is engaged, i.e. the shifting clutch 14′ is engaged, the assembly 19′ is in permanent driving connection with the input shaft GE. Due to the inertia-dependent torque of the power take-off drive PTO′ and the assembly 19′ attached thereto, that are counteracting a deceleration and an acceleration of the input shaft GE, the synchronization of the target gear would occur more slowly (from time t1 to t2*), corresponding to the dash-dotted curve progression for n_{GE}*, so that without further measures, the shifting procedure would be correspondingly delayed. Likewise, the subsequent further acceleration of the motor vehicle by the internal combustion engine VM would occur more slowly because the assembly 19′ attached at the power take-off drive PTO′ must also be accelerated.

In contrast, according to the invention with a switched on power take-off drive PTO′, the electric machine EM′ is controlled during and after the tractive upshift so that, during the synchronization of the target gear, it absorbs a braking torque (M_{EM}<0) in generator mode, and during the subsequent acceleration of the motor vehicle, in motor mode, it produces a driving torque (M_{EM}>0), which in each case corresponds as closely as possible to the inertia-dependent torque of the power take-off drive PTO′ and the assembly 19′ attached thereto, counteracting the deceleration or acceleration of the input shaft GE of the stepped transmission G, and compensates this torque. In the case of the tractive upshift considered here, an appropriate control of the electric machine EM′ results therefore ideally in the rotational speed progression n_{GE} corresponding to the solid line curve progression, so that the shift progression and the subsequent drive acceleration largely correspond to the progressions with the switched off power take-off drive PTO′.

### REFERENCE CHARACTERS

1, 1′ hybrid drive train
2 drive shaft of the internal combustion engine, crankshaft
3, 3′ rotor of the electric machine EM or EM′
4 flywheel of the internal combustion engine VM
5 clutch basket of the separating clutch K
6 driving plate of the separating clutch K
7 countershaft of the stepped transmission G
8 cardan shaft
9 axle differential
10a, 10b axle shafts
11a, 11b drive wheels
12, 12′ input side drive shaft of the power take-off drive PTO, PTO′
13, 13′ output side drive shaft of the power take-off drive PTO, PTO′
14, 14′ shifting clutch of the power take-off drive PTO, PTO′
15 drive wheel of the power take-off drive PTO
16, 16′ intermediate gear of the power take-off drive PTO, PTO′
17, 17′ drive wheel of the power take-off drive PTO, PTO′
18, 18′ output flange of the power take-off drive PTO, PTO′
19, 19′ assembly
20 reduction gear
21 sun gear
22 planet carrier
23 ring gear
24 fixed wheel of G2
EK input constant of G
EM, EM′ electric machine
G transmission, stepped transmission
G1-G4 forward gears
GA transmission output shaft

GE transmission input shaft
i transmission ratio
i_{EM}, i_{EM}′ transmission ratio of EM, EM′
i_{PTO}, i_{PTO}′ transmission ratio of the power take-off drive PTO, PTO′
J moment of inertia
J_{PTO}, J_{PTO}′ moment of inertia of the power take-off drive PTO, PTO′ and assembly 19, 19′
K separating clutch, friction clutch
M torque
M_{EM}, M_{EM}′ torque from EM or EM′
n speed of rotation
n_{GE}, n_{GE}* gear actuation rotational speed, rotational speed at GE
n_{Schalt} shifting rotational speed
n_{VM}, n_{VM}* rotational engine speed
n_{Ziel} target rotational speed
PTO, PTO′ power take-off drive
R reverse gear
t time
t1, t2, t2* time points
VM internal combustion engine

1-11. (canceled)

12. A method of controlling a hybrid drive train of a motor vehicle that comprises an internal combustion engine (VM) with a drive shaft (2), an automatic stepped transmission (G) with an input shaft (GE) that is connectable, via a controllable separating clutch (K), to the drive shaft (2) of the internal combustion engine (VM), an electric machine (EM), which is operable as a motor and as a generator, with a rotor (3) in driving connection with the drive shaft (2) of the internal combustion engine (VM), and a power take-off drive (PTO) in driving connection with the drive shaft (2) of the internal combustion engine (VM), and an assembly (19) attached to the power take-off drive (PTO) being driveable, the method comprising the step of:
largely compensating, during a controlled rotational speed change (dn_{VM}/dt) of the internal combustion engine (VM), an inertia-dependent torque of the power take-off drive (PTO) and the assembly (19) connected thereto that is counteracting a rotational speed change, by one of output or absorption of torque (M_{EM}) counter to that of the electric machine (EM).

13. The method according to claim 12, further comprising the step of, during an upshift within the stepped transmission (G), supporting an adaptation of a rotational speed of the internal combustion engine (VM) in that the electric machine (EM) in a generator mode absorbs a corresponding braking torque (M_{EM}<0).

14. The method according to claim 12, further comprising the step of, during a downshift within the stepped transmission (G), supporting an adaptation of a rotational speed of the internal combustion engine (VM) in that the elected machine (EM) in a motor mode produces a corresponding driving torque (M_{EM}>0).

15. The method according to claim 12, further comprising the step of determining an amount of the torque M_{EM} to be one of output or absorbed by the electric machine (EM) according to the equation:
M_{EM}J_{PTO}*π/(30* i_{EM}*i_{PTO}²)*dn_{VM}/dt
where J_{PTO} is the inertia-dependent torque of the power take-off drive (PTO) and the assembly (19) attached thereto, i_{EM} is a transmission ratio between the rotor (3) of the electric machine (EM) and the drive shaft (2) of the internal combustion engine (VM), i_{PTO} is a transmission ratio between the drive shaft (2) of the internal combustion engine (VM) and an output flange (18) of the power take-off drive (PTO), and dn_{VM}/dt is an intended rotational speed gradient at the drive shaft (2) of the internal combustion engine (VM).

16. A method of controlling a hybrid drive train of a motor vehicle that comprises an internal combustion engine (VM) with a drive shaft (2), an automatic stepped transmission (G) with an input shaft (GE) that is connectable, via a controllable separating clutch (K), to the drive shaft (2) of the internal combustion engine (VM), an electric machine (EM′), which is operable as a motor and a generator, with a rotor (3′) in driving connection with the input shaft (GE) of the stepped transmission (G), and a power take-off drive (PTO′) in driving connection with the input shaft (GE) of the stepped transmission (G), and an assembly (19′) attached to the power-take-off drive (PTO′) being driveable, the method comprising the steps of:
largely compensating, during a controlled rotational speed change (dn_{GE}/dt) of the internal combustion engine (VM), an inertia-dependent torque of the power take-off drive (PTO′) and the assembly (19′) connected thereto that is counteracting a rotational speed change, by one of output or absorption of torque (M_{EM}′) counter to that of the electric machine (EM′).

17. The method according to claim 16, further comprising the step of, during a tractive upshift within the stepped transmission (G), supporting a synchronization of a target gear in that the electric machine (EM′) in a generator mode absorbs a corresponding braking moment (M_{EM}′<0).

18. The method according to claim 16, further comprising the step of, during a tractive downshift within the stepped transmission (G), supporting a synchronization of a target gear in that the electric machine (EM′) in a motor mode produces a corresponding driving torque (M_{EM}′>0).

19. The method according to claim 16, further comprising the step of determining an amount of the torque (M_{EM}′) to be one of absorbed or output by the electric machine (EM′) according to the equation:
M_{EM}′=J_{PTO}′*π/(30*i_{EM}′*i_{PTO}′²)*dn_{GE}/dt
where J_{PTO}′ is a moment of inertia of the power take-off drive (PTO′) and of the assembly (19′) attached thereto, i_{EM}′ is a transmission ratio between the rotor (3′) of the electric machine (EM′) and the input shaft (GE) of the stepped transmission (G), i_{PTO}′ is a transmission ratio between the input shaft (GE) of the stepped transmission (G) and an output flange (18′) of the power take-off drive (PTO′), and dn_{GE}/dt is an intended rotational speed gradient at the input shaft (GE) of the stepped transmission (G).

20. The method according to claim 12, further comprising the step of outputting, during start-up with an initially slipping separating clutch (K), from the electric machine (EM, EM′) in a motor mode at least an appropriate driving torque (M_{EM}>0, M_{EM}′>0) for compensating the inertia-dependent torque of the power take-off drive (PTO, PTO′) and of the assembly (19, 19′) attached thereto.

21. The method according to claim 12, further comprising the step of switching on, during an acceleration of the motor vehicle during travel with an engaged separating clutch (K), the electric machine (EM, EM′) in a powerless idle state (M_{EM}=0, M_{EM}′=0) for compensating the inertia-dependent torque of the power take-off drive (PTO, PTO′) and the assembly (19, 19′) connected thereto, and then in a motor mode, providing with the electric machine (EM, EM′) an appropriate drive toque (M_{EM}>0, M_{EM}′>0), and an increased driving torque in a case in which the electric machine (EM, EM′) is already in the motor mode, and a correspondingly reduced braking torque in a case in which the electric machine (EM, EM′) is in a generator mode.

22. The method according to claim 12, further comprising the step of switching on, during a deceleration of the motor vehicle during travel with an engaged separating clutch (K), the electric machine (EM, EM′) in a powerless idle state (M_{EM}=0, M_{EM}′=0) for compensating the inertia-dependent torque of the power take-off drive (PTO, PTO′) and the assembly (19, 19′) connected thereto, and
then in a generator mode, absorbing with the electric machine (EM, EM′) an appropriate braking toque (M_{EM}<0, M_{EM}′<0), absorbing an increased braking torque in a case in which the electric machine (EM, EM′) is already in the generator mode, and providing a correspondingly reduced driving torque in a case in which the electric machine (EM, EM′) is in a drive mode.
